(19) United States
(12) Patent Application Publication
(10) Pub. No.: US 2023/0240942 A1
(43) Pub. Date: Aug. 3, 2023

(54) DEVICE FOR DISCHARGING LIQUID

(71) Applicant: Single Use Support GmbH, Kufstein (AT)

(72) Inventors: Daniel TISCHLER, Schwoich (AT); Barbara FISCHER, Kundl (AT); Hideki YAMAMOTO, Kobe (JP)

(21) Appl. No.: 18/103,905

(22) Filed: Jan. 31, 2023

(30) Foreign Application Priority Data
Feb. 1, 2022 (EP) 22154521.3

(51) Int. Cl. A61J 1/20; A61J 1/10; A61J 1/16

(52) U.S. Cl. CPC A61J 1/2003; A61J 1/10; A61J 1/16

(57) ABSTRACT

Device for discharging liquid (2), in particular a biopharmaceutical liquid, from a flexible container (3) comprising an inclined plane (4) and a kneading mechanism (5) for kneading the flexible container (3) and its contents while the flexible container (3) rests on the inclined plane (4).

The present invention is concerned with a device for discharging a liquid, in particular a biopharmaceutical liquid, from a flexible container.

In the biopharmaceutical production process so-called single use bags are often used in order to transport a biopharmaceutical drug or other liquids in the biopharmaceutical production process. Single use bags have advantages when it comes to transportation and protection of said liquids as the single use bags can easily be filled and the contents can easily be frozen, transported, and thawed. In the frozen state the liquid is protected and comparatively easy to handle.

Most of the described steps can be automatised which is why the process described above is quite effective. However, in practice the single use bags are still emptied by hand because the liquids occurring in the biopharmaceutical production process need to stay homogenised. Therefore, the person who empties the single use bag continuously kneads the bag while emptying it.

While this works quite well in practice it would be desirable to improve the process regarding reproducibility as different persons will of course knead the single use bags in different manners.

The object of the invention is therefore to provide a device and a method for improving the protection and transportation process of biopharmaceutical liquids regarding reproducibility.

Regarding the device this object is achieved with the features of claim 1, namely by a device comprising an inclined plane and a kneading mechanism for kneading the flexible container and its contents while the flexible container rests on the inclined plane.

Regarding the method the object is achieved with the features of claim 14, namely wherein the flexible container is placed on an inclined plane, a kneading mechanism is used, which kneading mechanism kneads the flexible container and its contents while the flexible container rests on the inclined plane, and discharging the liquid from the flexible container.

In and of itself using another device for kneading next to the many devices used for filling the liquid in a flexible container, freezing the container and its contents, transportation, and thawing the container and its contents seems to be disadvantageous because it further increases the complexity of the process. It should be noted that every device used in the biopharmaceutical production process is subject to strict requirements, checks, and validation procedures.

The result of the inventor's analysis was therefore highly surprising because it suggested that using an extra device in the process for emptying the containers in fact outweighs the additional effort described above because the almost perfect reproducibility achieved therewith has quite significant positive effects on the yield and quality of the production as a whole.

Commonly, pumps, in particular peristaltic pumps, are used for conveying the liquid after discharge from the flexible container. According to the invention the discharging of the liquid is assisted by the gravitational force acting on the liquid in the flexible container resting on the inclined plane. Another advantage of the invention is that bubbles within the liquid in the flexible container will float to the top of the inclined plane which prevents that the bubbles get sucked out of the bag by the action of the pump. This positive effect is supported by the kneading action of the kneading mechanism which disturbs the liquid and ensures that bubbles find their way to the top of the surface of the liquid/top of the inclined plane.

Biopharmaceutical liquids can be understood as any liquid occurring in the biopharmaceutical production process. Examples would be protein solutions, end products from a purification procedure, antibody solutions and other, in many instances high-value, intermediate products in the pharmaceutical production cycle, and naturally the medicines themselves.

Protection is also sought for the use of the device according to the invention for discharging a liquid, in particular a biopharmaceutical liquid, from a flexible container.

The word “discharging” can be understood as completely or partially emptying the container for the purposes of this invention.

In preferred embodiments the flexible container is a single use bag. Single use bags are known to persons in the biopharmaceutical production industry as certain bags formed by at least two plastic foils welded at the periphery and provided with one or more ports. They can have varying capacity from below one litre to and above 20 litres. Common capacities of single use bags comprise 20 ml and 1 l.

The kneading mechanism according to the invention exerts differing pressures on different regions of the flexible container in order to move the liquid inside the flexible container so as to reach a mixing effect within the liquid. Adequate or excellent, if not necessarily perfect, homogeneity of the liquid stored in the flexible container is maintained in this way while the liquid discharges because of the inclined plane.

In preferred embodiments of the invention the kneading mechanism will exert said pressure by contacting the flexible bag directly or through a flexible intermediate layer. However, embodiments with contactless kneading are in principle conceivable (e.g. using electric and/or magnetic fields).

All aspects of the present disclosure which has been described with respect to the device according to the invention can also be used and/or provided together with the method and the use according to the invention.

Further preferred embodiments of the invention are defined in the dependent claims.

The kneading mechanism can comprise at least two kneading elements and a drive train for moving the kneading elements, preferably in a periodic manner and/or in an acyclic manner.

Acyclic kneading can be understood as kneading not in a synchronised manner. Particularly preferably the kneading action of the kneading elements can be exactly anti-cyclic, i.e., when one of the kneading elements is furthest away from the flexible container and/or exerts a minimum force onto the flexible container the other kneading element is closes to the flexible container and/or exerts the maximum force thereon.

The at least two kneading elements can preferably be of substantially flat configuration. In other words, the kneading elements can be paddles which knead the flexible container and the contents of the flexible container with their flat sides.

In preferred embodiments the kneading mechanism can comprise a rocker link and a drive motor for moving the rocker link.

The drive motor can preferably be an electric motor with variable speed. In preferred embodiment an operator of the device according to the invention can adjust the speed of the drive motor and/or the kneading action.

The rocker link can substantially be of T-shape, and/or at least two kneading elements can be attached to a first, preferably longer, arm of the rocker link, and/or the drive motor can drive the rocker link on a second, preferably shorter, arm of the rocker link through an excentric.

The eccentricity of the eccentric may define the stroke length of the motion of the kneading elements.

A stroke length of the kneading elements can be adjustable. Therefor the eccentric can be embodied with adjustable excentricity.

“Substantially” of T-shape can for example mean that there are further geometrical features (e.g. guides, fixing elements and the like) beyond the substantial T-shape.

The at least two kneading elements can be attached to the rocker link via lifting rods.

A drive side of the drive motor and/or the at least two kneading elements and/or the lifting rods can be attached to the rocker link by engagement with at least one elongated hole. The elongated holes allow linear motion and rotations of the element engaging with the elongated hole so that the elements can maintain lateral or vertical positions even though the rocker link pivots.

For example, bolts can be used to engage with the elongated holes. The term “bolt” is to be understood broadly in this context. That is, any type of pin, through bolt, or axle can serve as bolt for attaching the drive side of the drive motor and/or the at least two kneading elements and/or the lifting rods to the rocker link.

In other embodiments for example the eccentric can directly engage with an elongated hole.

The inclined plane can be at an angle of between 1° and 60°, preferably between 1° and 30°, particularly preferably between 2° and 8°, relative to the horizontal.

In particularly preferred embodiments the inclined plane is realised by a surface of a cooling plate for cooling the flexible container and its contents. Such a cooling plate can be used to keep the flexible container and the contents thereof at optimum or near optimum temperatures. In particular for biopharmaceutical liquids this can result in a major improvement over the prior art where the liquids and flexible bags have been handled extensively by personnel. Biopharmaceutical liquids in many instances exhibit a strong sensitivity for too high temperatures even at or below the body temperature of a human which can result in degradation of the liquid and/or compounds in the liquid.

In such particularly preferred embodiments, the cooling plate and/or the liquid can be kept at temperatures between 2° C. and 8° C.

The cooling plate can have an internal conduit for cooling medium which is conveyed through the cooling plate. The cooling medium can absorb heat from the liquid to be cooled through the surface of the cooling plate whereby the absorbed heat can be lead away resulting in the desired cooling action.

The cooling can be closed or open loop controlled to keep the temperatures in a desired window or at a desired target temperature.

In preferred embodiments a control device is provided, preferably which control device
closed loop controls an operation of a cooling device using feedback signals of a temperature sensor and/or
open loop controls the drive motor of the drive train.

The temperature sensor can be arranged on the cooling plate and/or can be inset into a recess of the cooling plate.

The cooling plate as well as the supply of cooling medium can for example be embodied as described in the yet undisclosed European Patent Application no. 21202961.5.

Some details regarding cooling plates can also be taken from the yet undisclosed European Patent Application no. 21203453.2.

Further advantages and embodiments are apparent from the figures and the accompanying description of the figures which show:

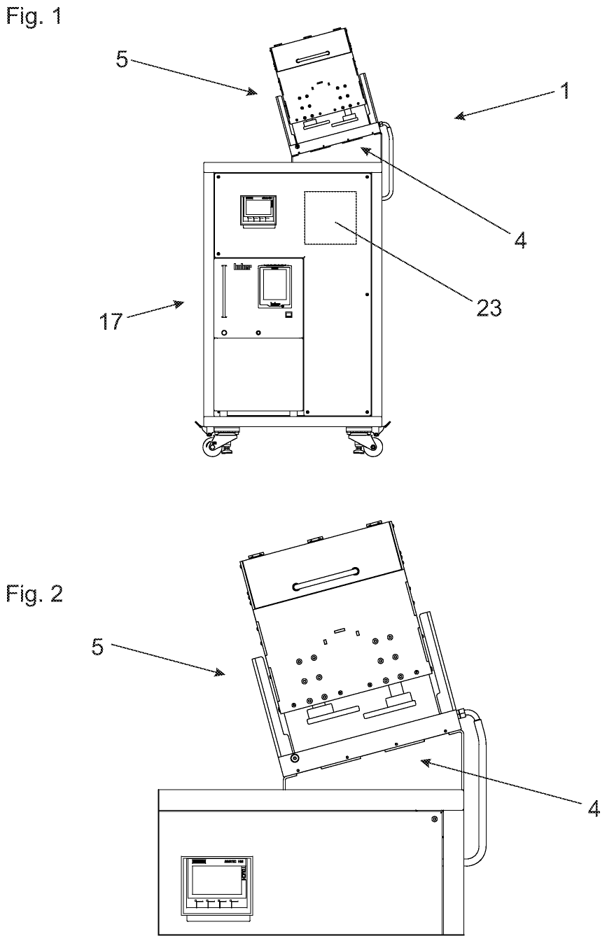

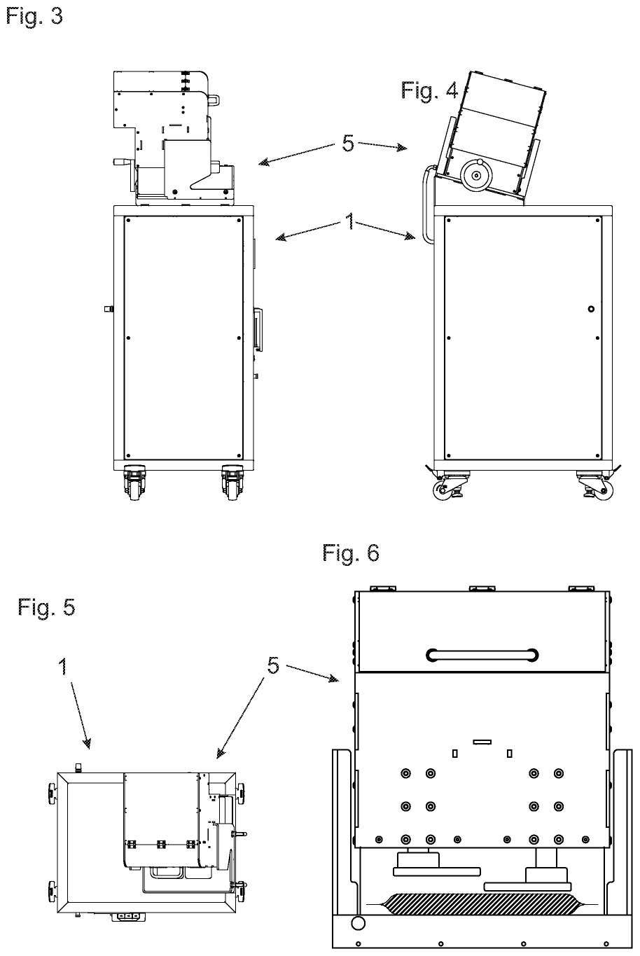

FIG. 1 to 6 different views of an embodiment of a device according to the invention,

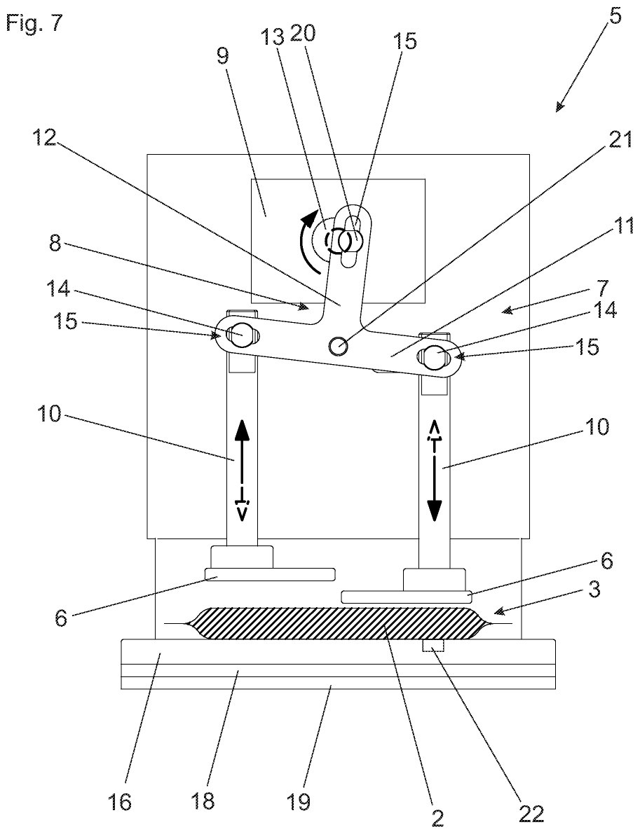

FIG. 7 a detailed view of the kneading mechanism of the embodiment of FIG. 1 to 5, and

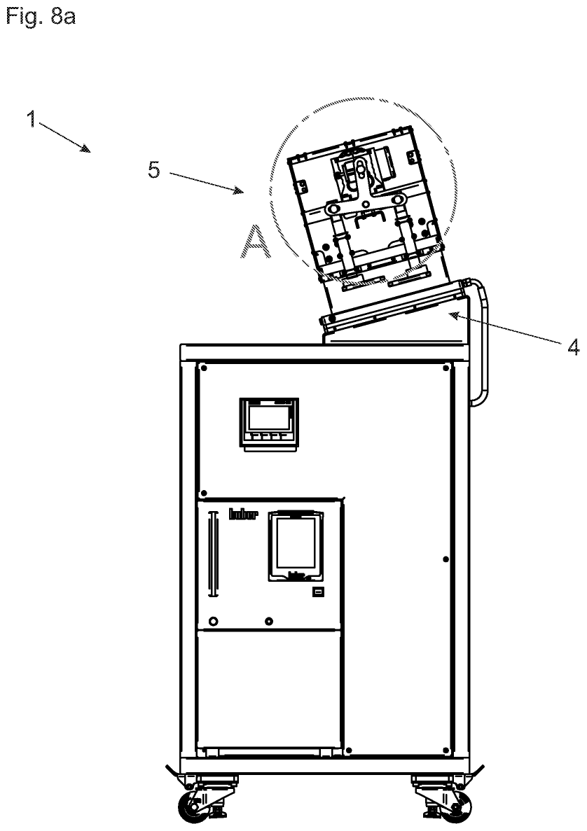

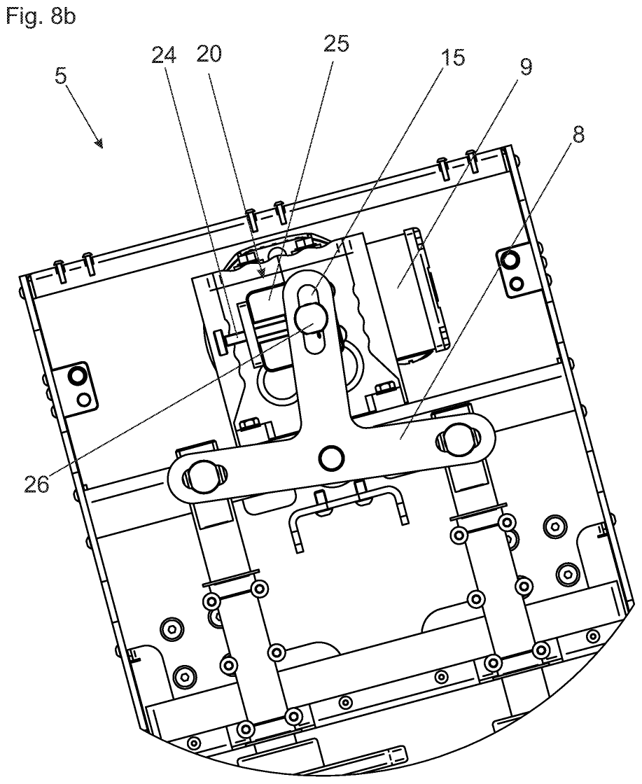

FIGS. 8a and 8b further detailed views of an embodiment of a kneading mechanism according to the invention.

FIGS. 1, 3, 4, 5 and 6 show an embodiment of a device according to the invention in a front view, a side view, a rear view, a top view, and a detailed view, respectively.

The device comprises an inclined plane 4 and a kneading mechanism 5.

Additionally, a control device 17 is present for controlling the kneading mechanism.

Schematically a cooling device 23 is indicated.

FIG. 2 shows the kneading mechanism 5 and the inclined plane 4 in greater detail.

FIG. 6 shows the kneading mechanism 5 on its own from an outside.

FIG. 7 shows the kneading mechanism 5 and the inclined plane 4 in yet greater detail and shows an inside view of the kneading mechanism 5.

The kneading mechanism 5 comprises a drivetrain 7.

The drivetrain 7 comprises an electric motor drive 9 and a substantially T-shaped rocker link 8 which is rotatably mounted on a pivot 21. The drive side 13 of the electric motor drive 9 is connected to the second arm 12 of the rocker link 8 through an eccentric 20, the second arm 12 of the rocker link 8 being somewhat shorter than the first arm 11 of the rocker link 8.

The pivot 21 is situated at an intersection between the first arm 11 and the second arm 12.

The eccentric 20 is visualized as a dashed circle representing a drive axle of the drive side 13 of the drive motor and an offset actuating element of the eccentric 20 engaged with the second arm 12.

Through the rotation of the eccentric 20 (indicated by an arrow) the rocker link 8 is pivoted from side to side resulting in anti-cyclic movements of the two sides of the first arm 11. An elongated hole 15 with which the actuating element of the eccentric 20 engages compensates linear and rotational motion of the eccentric 20 relative to the rocker link 8.

On both sides of the first arm 11 of the rocker link 8 lifting rods 10 are mounted via bolts 14 which engage with elongated holes 15 in the two sides of the first arm 11. Like the elongated hole 15 in the second arm 12 the elongated holes 15 in the first arm 11 compensate relative linear and rotational motion between the rocker link 8 and the lifting rods 10.

In the present example embodiment, the lifting rods 10—as well as all other moving parts of the kneading mechanism 5—are guided by plain bearings/sliding bearings.

In this embodiment the plain bearings are all FDA-certified. They are extremely abrasion resistant such that a very low amount of particles are created by the gliding along the bearing. In this way the device according to the invention 1 can be made usable in a clean room.

The lifting rods 10 carry kneading elements 6 on the respective other end such that the anti-cyclic movement of the two sides of the first arm 11 is transferred onto the kneading element.

The kneading elements 6 are of a substantially flat configuration and are roughly shaped like paddles.

In FIG. 7 the kneading elements 6 are shown at an intermediate position during the periodic movement. In this position there is temporarily no contact between the kneading elements 6 and the flexible container 3, in this embodiment a single use bag.

Because of the rotation of the eccentric 20 and the resulting motion of the rocker link 8 the left kneading element 6 will be moved downwards, will contact the flexible container 3, and will exert a force on the container 3. In a repeating pattern this will continue with the kneading elements 6 alternately exerting a force on the container 3. Since the container is flexible this results in a kneading action on the liquid 2 inside the container.

The inclined plane 4 is realized as an upper surface of the cooling plate 16. It should be noted that even though the cooling plate is drawn horizontally in FIG. 6 it is of course arranged at an angle as can be seen in FIG. 1 to 6.

The cooling plate 16 is mounted on a base plate 19. Between the base plate 19 and the cooling plate 16 there is an insulating plate 18 which decouples the base plate 19 and the cooling plate 16 thermally.

The cooling plate 16 has at least one internal conduit through which cooling medium (e.g. a water glycol mixture and/or a silicone oil) can be conveyed. A water glycol mixture may be preferred as it can be used over a wide range of temperatures, e.g. between −10° C. to +40° C. The device 1 comprises a cooling device 23 which, as mentioned before, is shown in FIG. 1 schematically. The cooling device 23 cools the cooling medium and conveys the cooling medium through the at least one internal conduit of the cooling plate 16.

In this embodiment a temperature sensor 22 is incorporated into the cooling plate which provides feedback signals to the control device 17 for a closed loop control of the temperature of the cooling medium, the cooling plate, the flexible container, and/or the liquid stored in the container.

Based on the feedback signal the control device 17 can command for example a pump or a valve of the cooling device 17 so that a commanded amount of heat is transferred away from the cooling plate 16. A predefined temperature and/or temperature profile can therefore be held at the cooling plate 16.

Details of an example of a cooling plate as well as an example of the supply of cooling medium can for example be taken from the yet undisclosed European Patent Application no. 21202961.5.

The aforesaid makes it clear how the liquid 2 is discharged from the container 3 because of the inclined plane 4, potentially supported by the action of a pump pumping the liquid, how the liquid 2 is kneaded and therefore kept homogeneous, and how the liquid is cooled, all at the same time. Human intervention during the discharge process is therefore not needed.

In the present embodiment, the control device 17 comprises separate controls for the cooling and for the control of the speed of the drive motor 9 as well as a control unit tied to a human machine interface. The different control units communicate via a bus system, in this exemplary embodiment a Profinet bus.

The feedback signals of the temperature sensor 22 are delivered to the control unit tied to the human machine interface, where the feedback signal is compared to a target value which can be adjusted at the human machine interface. Based on the comparison a command value is calculated and delivered to the control unit of the cooling device 23 via the bus system (the control unit of the cooling device 23 is rated as “slave” in the bus system).

The drive motor 9 is open loop controlled in this embodiment. A desired speed can be set at the human machine interface and this desired speed is delivered via the bus system to the control unit of the drive motor 9 which in this case is a frequency converter which directly supplies the drive motor 9 with the appropriate voltage and/or current.

FIG. 8a shows the embodiment of FIG. 1 to 6 in a view where a cover of the kneading mechanism 5 has been opened so that the inside of the kneading mechanism is visible.

In this embodiment removing the cover will interrupt a security circuit and cause the control unit 17 to command a standstill of the drive motor 9 and therefore the kneading mechanism 5.

FIG. 8b shows detail A of FIG. 8a.

FIG. 8b in particular shows an example of an eccentric 30 with adjustable eccentricity. The eccentric 20 comprises a base element 25 which is rotated by the drive side 13 of the drive motor 9.

An engagement element 26 is mounted on the base element 25. The engagement element 26 engages with the elongated hole 15 in the second arm 12 as described in connection with FIG. 7.

The eccentricity of the eccentric 20 is defined by the distance between the axis of rotation of the drive side 13 of the drive motor 9 (see dashed circle in FIG. 7) and the engagement element 26.

This distance can be adjusted using an adjustment screw 24 which in this embodiment co-rotates with the eccentric 20. Adjusting the screw will change the movement range of the rocker link 8, which in turn leads to different stroke lengths of the kneading elements 6. In the present example the stroke length can be adjusted between 0 mm and 10 mm.

### REFERENCE NUMERALS

1 device
2 liquid
3 flexible container
4 inclined plane
kneading mechanism
6 kneading elements
7 drive train
8 rocker link
9 drive motor
10 lifting rods
11 first arm
12 second arm
13 drive side
14 bolt
15 elongated hole
16 cooling plate
17 control device
18 insulating plate
19 base plate
20 eccentric
21 pivot
22 temperature sensor
23 cooling device
24 adjustment screw
25 base element
26 engagement element

1. Device for discharging liquid, in particular a biopharmaceutical liquid, from a flexible container comprising an inclined plane and a kneading mechanism for kneading the flexible container and its contents while the flexible container rests on the inclined plane.

2. The device according to claim 1, wherein the kneading mechanism comprises at least two kneading elements and a drive train for moving the kneading elements, ably in a periodic manner and/or in an acyclic manner.

3. The device according to claim 2, wherein the at least two kneading elements are of substantially flat configuration.

4. The device according to claim 1, wherein the kneading mechanism comprises a rotatable rocker link and a drive motor for moving the rocker link.

5. The device according to claim 4, wherein
the rocker link is substantially of T-shape, and/or
at least two kneading elements are attached to a first, preferably longer, arm of the rocker link, and/or
and the drive motor drives the rocker link on a second, preferably shorter, arm of the rocker link through an eccentric.

6. The device according to claim 5, wherein the at least two kneading elements are attached to the rocker link via lifting rods.

7. The device according to claim 5, wherein a drive side of the drive motor and/or the at least two kneading elements and/or the lifting rods are attached to the rocker link by engagement with at least one elongated hole.

8. The device according to claim 1, wherein the inclined plane is at an angle of between 1° and 60°, preferably between 1° and 30°, particularly preferably between 2° and 8°, relative to the horizontal.

9. The device according to claim 1, wherein the inclined plane is realized by a surface of a cooling plate for cooling the flexible container and its contents.

10. The device according to claim 1, wherein a control device is provided, preferably which control device
closed loop controls an operation of a cooling device using feedback signals of a temperature sensor and/or
open loop controls the drive motor of the drive train.

11. The device according to claim 10, wherein the temperature sensor is arranged on the cooling plate and/or is inset into a recess of the cooling plate.

12. Use of a device according to claim 1 for discharging a liquid, in particular a biopharmaceutical liquid, from a flexible container.

13. Use of a device according to claim 12, wherein the flexible container is a single use bag.
